(19) United States
(12) Patent Application Publication
(10) Pub. No.: US 2010/0176993 A1
(43) Pub. Date: Jul. 15, 2010

(54) COMMUNICATIONS UNIT WITH A BUILT-IN ANTENNA

(76) Inventor: Gert Frølund Pedersen, Storvorde (DK)

Correspondence Address: Altera Law Group, LLC, 220 S 6 St Suite 1700, Minneapolis, MN, 55402, US

(21) Appl. No.: 12/063,068

(22) PCT Filed: Aug. 11, 2006
(86) PCT No.: PCT/DK06/00443

§ 371 Date: Mar. 23, 2010

(30) Foreign Application Priority Data
Aug. 12, 2005 (DK) PA 2005-01133

(51) Int. Cl. H01Q 1/24

(52) U.S. Cl. 343/702

(57) ABSTRACT

In a communications unit, such as a headset or a hearing aid, of the wireless type, a metal layer (3) is adhered or secured to its battery (1) by means of a double adhesive tape or spacers (2), so that the battery and the metal layer are capacitively connected to each other. The metal layer (3) is connected electrically to the transmit and receive circuit of the communications unit, which is mounted on a printed circuit board whose ground parts constitute a ground plane. Hereby, a patch antenna is provided, which, although it has small dimensions, has a good directional characteristic, which additionally provides the advantage that radiation from the antenna is directed away from a user's head. A communications unit constructed in this manner is useful in connection with a Bluetooth communications connection.

The invention relates to a communications unit comprising a microphone, a speaker, an electrical transmit and receive circuit on a printed circuit board as well as a battery and an antenna.

Communications units of the above-mentioned type have, small physical dimensions, which makes demands on the antenna design, as the size and the position of the antenna in the communications unit affect its efficiency expressed by its transfer characteristic, i.e. directional characteristic, gain, frequency characteristic and resonance.

An ordinary way of building an antenna into a communications unit is to build it into the printed circuit board of the communications unit as a so-called Planar Inverted F antenna. Such an antenna per se has small dimensions and must therefore be connected to other components which form part of the headset, which requires that these components are positioned very accurately relative to each other owing to the electrical and electromagnetic properties of the antenna.

GB 2 402 835 discloses a wireless communications unit, here in the form of a headset, where an external antenna is connected so as to enable communication to peripheral units via a Bluetooth connection.

A communications unit, also in the form of a headset, of the type defined in the introductory portion of claim 1 is known from US Patent Application No. 2004/0204198. According to this patent application, the antenna is, built into a sound pipe to a microphone and connected to an integrated circuit which contains a transmit and receive circuit.

This known antenna cannot be used in connection with a communications unit where the microphone is not connected to a sound pipe, as the dimensions of the antenna cannot be reduced while maintaining an acceptable characteristic.

Accordingly, an object of the invention is to provide a communications unit, where, in spite of the restricted space in the communications unit, its antenna has an optimum transfer characteristic.

The object of the invention is achieved by a communications unit of the type defined in the introductory portion of claim 1, which is characterized in that the antenna is formed by the battery and a metal layer which are capacitively connected to each other, wherein the metal layer is connected electrically to the transmit and receive circuit, and wherein the ground parts of the printed circuit board constitute the ground plane of the antenna.

Here, a so-called patch antenna is provided, which requires less space and has a good transfer characteristic, which is optimum in connection with a Bluetooth communications connection or another wireless communications connection.

To implement the invention, it is advantageous if, as stated in claim 2, the communications unit is formed by a headset, or, as stated in claim 3, by a hearing aid.

The capacitive connection may be effected in a simple manner, as stated in claim 4, in that the metal layer is adhered to the surface of the battery by means of a double adhesive tape.

Alternatively, the capacitive connection may be effected, as stated in claim 5, in that the metal layer is secured to the surface of the battery by means of a plurality of electrically insulated spacers in the form of pipe parts, through which fasteners, such as screws of insulated material, are passed, so that the metal layer is secured at a distance from the surface of the battery, said screws being tightened by means of electrically insulated nuts.

When, as stated in claim 6, the metal layer is adhered to the surface of the battery which faces toward the electrical transmit and receive circuit, it is ensured that the radiation of the antenna is directed away from a user's head, because the surface of the printed circuit board is larger than the battery and the metal layer.

Expediently, as stated in claim 7, the communications unit communicates with other communications units via a Bluetooth connection.

A particularly expedient way of connecting the antenna to the transmit and receive circuit of the communications unit is, as stated in, claim 8, that, on part of its surface, the metal layer is provided with conductor parts which are disposed perpendicularly to the surface of the metal layer.

It is expedient, as stated in claim 9, that the conductor parts are connected to the ground plane of the printed circuit board, while the conductor path is connected to the transmit and receive circuit.

In order to provide optimum antenna efficiency, it is advantageous if, as stated in claim 10, the components disposed on the printed circuit, board, which is multi-layered, are disposed as close to the conductor part as possible, and that the surface of the printed circuit board directly below the metal layer contains as much ground as possible.

The invention will now be explained more fully with reference to the drawing, in which

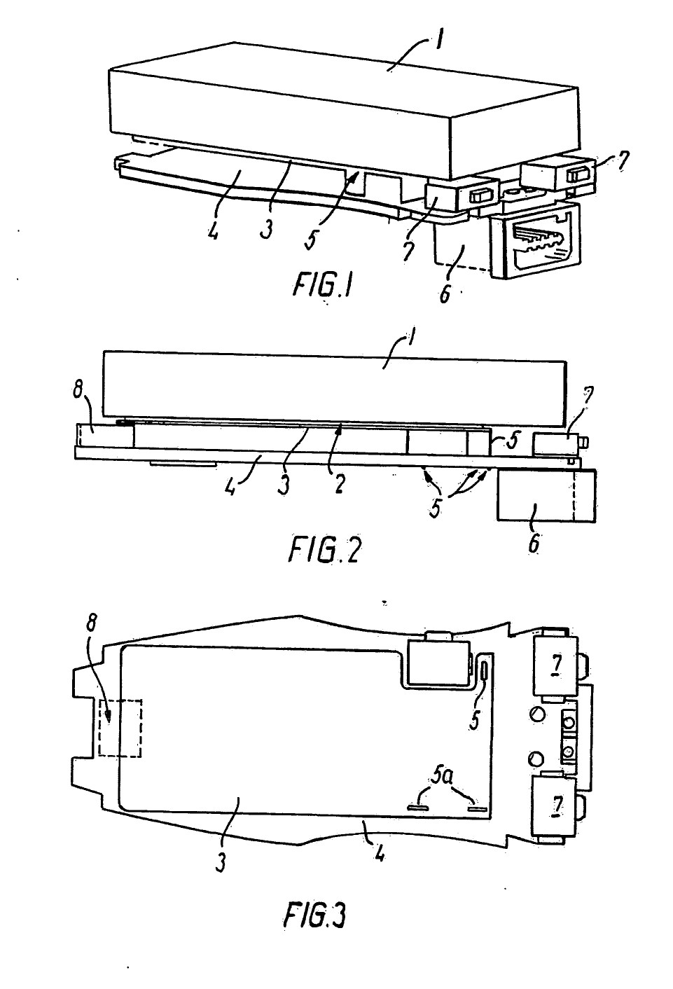

FIG. 1 shows the structure of a communications unit with an antenna according to the invention on an enlarged scale,

FIG. 2 shows the communications unit of FIG. 1, seen from the side, while

FIG. 3 shows the communications unit of FIG. 1, seen from the top, but without a battery.

In the figures, the numeral 1 designates a battery for a communications unit, which may be a headset or a hearing aid. The numeral 3 designates a metal layer, while the numeral 4 designates a printed circuit board which contains a transmit and receive circuit.

The numeral 6 designates a plug connection for the communications, unit, while the numeral 7 designates push buttons for use in the functional activation of the communications unit.

The plug connection may e.g. be used for connecting the communications unit to a base unit, which contains a charger, e.g. as described in WO 2005/032109 A1.

In addition, the numeral 8 designates a housing for a microphone (not shown). The communications unit moreover has a speaker (not shown).

Further, all the parts are built into a housing (not shown) which has an ear hook.

The battery is adhered by means of a double adhesive tape 2 to a metal layer 3, which is connected electrically to the printed circuit board by means of conductor parts 5, 5a arranged perpendicularly to the metal layer, where conductor parts 5 are connected to the ground plane of the printed circuit board, while the conductor part 5a is connected to the transmit and receive circuit, so that RF signals may be transferred to and from the transmit and receive circuit through the conductor part 5a.

It is also possible to do this in the reverse order, if conditions so permit.

Alternatively, the metal layer may be secured to the battery by means of a suitable number of spacers, e.g. four, in the form of electrically insulated pipe parts with holes, through which electrically insulated screws and nuts may be used for clamping the battery and the metal layer together through pre-drilled holes in the metal layer and the battery, so that the battery and the metal layer are disposed at a distance from each other which corresponds to the length of the spacers.

The components placed on the printed circuit board, which is multi-layered, are disposed close to the conductor part 5a to the greatest extent possible; and either on the lower side of the printed circuit board or between the layers, whereas as few components as possible are disposed on the surface of the printed circuit board.

Likewise, the paths of the printed circuit board are disposed between the layers to the greatest extent possible, so that bores through the printed circuit board are avoided, which has an adverse impact on the efficiency of the antenna.

Finally, the surface of the printed circuit board immediately below the metal layer is kept as uninterrupted by paths and holes as possible.

Hereby, a so-called patch antenna is provided, which is formed by the metal layer 3 which is coupled capacitively to the battery 1 of the communications unit and the printed circuit board 4, said printed circuit board constituting a ground plane for the antenna.

The antenna has a directional characteristic which radiates from the surface of the battery, which means that radiation toward a user's head is minimized, as the communications unit is to be placed on a user's head so that the printed circuit board is fairly parallel to the user's ear.

Finally, it is noted that if the outer surface of the battery is not of metal; a metal layer or some metal strips may be adhered to its surfaces.

1. A communications unit comprising a microphone, a speaker, an electrical transmit and receive circuit on a printed circuit board as well as a battery (1) and an antenna, wherein the antenna is formed by the battery (1) and a metal layer (3) capacitively connected to each other, wherein the metal layer is connected electrically to the transmit and receive circuit, and wherein the ground parts of the printed circuit board constitute the ground plane of the antenna.

2. A communications unit according to claim 1, wherein it is formed by a headset.

3. A communications unit according to claim 1, wherein it is formed by a hearing aid.

4. A communications unit according to claim 1, wherein the metal layer (3) is adhered to the surface of the battery by means of a double adhesive tape (2).

5. A communications unit according to claim 1, wherein the metal layer (3) is secured to the surface of the battery by means of a plurality of electrically insulated spacers in the form of pipe parts, through which fasteners, such as screws of insulated material, are passed, so that the metal layer is secured at a distance from the surface of the battery, said screws being clamped by means of electrically insulated nuts.

6. A communications unit according to claim 1, wherein the metal layer (3) is adhered or secured to the surface of the battery which faces toward the electrical transmit and receive circuit.

7. A Communications unit according to claim 1, wherein it communicates with other communications units via a Bluetooth connection.

8. A communications unit according to claim 1, wherein on part of its surface, the metal layer (3) is provided with conductor parts (5, 5a) which are disposed perpendicularly to the surface of the metal layer.

9. A communications unit according to claim 8, wherein the conductor parts (5) are connected to the ground plane of the printed circuit board, while the conductor path (5a) is connected to the transmit and receive circuit.

10. A communications unit according to claim 8, wherein the components disposed on the printed circuit board, which is multi-layered, are disposed as close to the conductor part (5a) as possible, and that the surface of the printed circuit board directly below the metal layer contains as much ground as possible.
